(19) United States
(12) Patent Application Publication
(10) Pub. No.: US 2005/0000334 A1
(43) Pub. Date: Jan. 6, 2005

(54) Rotary film cutting apparatus and method

(76) Inventors: Norman P. Friedrich, Union, NJ (US); John G. Friedrich, Mountainside, NJ (US)

Correspondence Address: KAPLAN & GILMAN , L.L.P., 900 ROUTE 9 NORTH, WOODBRIDGE, NJ, 07095, US

(21) Appl. No.: 10/872,698

(22) Filed: Jun. 21, 2004

Related U.S. Application Data
(60) Provisional application No. 60/479,951, filed on Jun. 19, 2003.

(51) Int. Cl. B26D 1/00

(52) U.S. Cl. 83/13; 83/663

(57) ABSTRACT

An apparatus and method for separating webs of film transversely, the apparatus comprising a web holding apparatus, a device for advancing said web to a cutting apparatus, a rotary cutting device, and a device for providing containers to be filled with lengths of cut film, and a means for controlling the operation of the apparatus. A slitting device is provided for cutting said web longitudinally prior to said transverse cut. A method is provided for cutting at least one film web employing a rotary cutting tool, providing a container for receiving cut film lengths, and loading said cut lengths in a container. A method is provided for disposing a cap on a container of cut film lengths.

### REFERENCE TO RELATED APPLICATIONS

This application claims the benefit of U.S. Provisional Patent Application No. 60/479,951, entitled “Rotary Film Cutting Machine And Method,” filed Jun. 19, 2003; the entire disclosure of which is hereby incorporated by reference.

### FIELD OF THE INVENTION

The invention relates generally to an apparatus and method for the separation of material webs, particularly film webs.

### BACKGROUND OF THE INVENTION

Web cutting devices consisting of a reciprocating knife extending transversely with respect to the direction of movement of the web are known in the art.

However it is not known to provide in a single machine a rotary cutting apparatus for cutting film webs to predetermined lengths, and furthermore providing a plurality of containers for receiving said cut lengths and filling said containers with said cut lengths. The apparatus and method provided herein permit a rapid and efficient means of preparing a plurality of cut film lengths such as those used for breath freshening, confections and delivery of vitamins and medicaments.

### SUMMARY OF THE INVENTION

The present invention is an apparatus and method for cutting webs of film, the apparatus comprising a web holding means, a means for advancing said web to a cutting station, and a cutting device. The invention further comprises a dispenser for providing containers to be filled with cut lengths, and a means for controlling the operation of the apparatus.

In a preferred embodiment the cutting device of the present invention comprises a rotary cutting tool preferably having a plurality of cutting surfaces. The rotary cutting tool is preferably generally cylindrical in cross-section, having cutting surfaces disposed longitudinally on its surface. The cutting tool is preferably unitary in construction wherein cutting surfaces are integral with said body. Alternatively said cutting surfaces are removable from said body.

A cutting block is fixed opposite said rotary tool. As the cutting tool rotates the cutting surfaces contact the cutting block. The cutting tool is preferably self-sharpening. Preferably the cutting block is provided with plural surfaces against which the cutting tool can be contacted. In one embodiment the cutting block is adjustable so that the surface against which the cutting tool is contacted can be changed.

A web of film is advanced between the cutting tool and cutting block. The web of film may be supported such as but not limited to, on a web of carrier film such as Mylar, or unsupported. Where the film is supported a takeup spool is employed to remove the carrier. Preferably the web is advanced between rollers to the cutting tool.

The web is preferably provided in the form of a coil that is mountable on a reel of the apparatus and fed through pinch rollers to the cutting tool. The apparatus is adapted to accommodate mounting of a coil to provide a top or bottom feed. In this manner problems associated with curling of the leading end of the web can be mitigated. That is, for example where a particular web is exhibiting an upward curl at its leading edge the coil can be removed and turned over to provide a feed that has a downward curl, and vice versa. Heat may be applied to mitigate curl.

In a preferred embodiment plural film webs are cut simultaneously.

The cutting tool preferably rotates a predetermined number of times as the film is advanced, resulting in a plurality of cut-to-size lengths of film. The film is cut by a pinching action of the cutting surfaces as the cutting surfaces contact the cutting block. The rotary action of the cutting tool advances the cut lengths of film to a filling station.

In another embodiment the film web is cut longitudinally prior to being fed to the rotary cutting device, creating plural parallel webs from a single feed roll. This embodiment may also be employed where plural film webs are cut simultaneously.

In a preferred embodiment a dispenser such as but not limited to a chute dispenser holds a plurality of containers for receiving the cut lengths. A plurality of cut lengths is thus filed into each successive container with each rotation cycle of the cutting tool. At the conclusion of each cycle the filled container is advanced along a channel out of the way of the filling station, the next container taking its place for filling.

A control system is provided to control the operation of the apparatus. A user interface such as but not limited to a touch screen is provided to permit an operator to control the various parameters of the operation of the apparatus. For example, roller speed, torque, rotations per cycle, etc. are input by the operator on a touch screen which is linked to a CPU which is in turn operatively linked to the various motor drives of the apparatus. In a preferred embodiment, the touch screen communicates with a first motor and the actions of the remaining motors are governed by the actions of the first motor.

In a further embodiment the machine comprises a container sealing means that seals each container after it is loaded. Filled containers are advanced along a channel to the sealing station where a cover is disposed over said container. In a preferred embodiment a cover-dispensing device such as but not limited to a chute dispenser or magazine is configured to dispense a plurality of container covers. The cover dispensing device dispenses a cover to the sealing station where said cover is disposed on a container and advanced out of the sealing station. In one embodiment, a spring loaded pushing plunger situated under the channel drives the container into the cover, which is adapted to securely engage the container. Preferably, the cover is adapted to hook onto the edge of a container and the container and cover are passed through pinch rollers to securely fasten the cover to the container with the film inside. The plunger then returns to the ready position.

Films such as but not limited to confectionary films, breath freshening films, vitamin films and medicinal films are suitable for use in the present apparatus. In a preferred embodiment the web is a thin film comprising a confection such as a cornstarch-based confection. In one embodiment the confection is in the nature of a breath freshening “tape” for example the commercially available Listerine™ brand tape. In edible film applications the apparatus is preferably operated in a climate-controlled environment, since undue humidity or elevated temperature can adversely affect the film.

### OBJECTS OF THE INVENTION

It is an object of the present invention to provide an apparatus for cutting at least one web of film transversely to a plurality of predetermined lengths of film.

It is another object of the present invention to provide an apparatus for cutting at least one web of film transversely to a plurality of predetermined lengths of film and filling containers with said plurality of cut lengths.

It is another object of the present invention to provide a method for cutting at least one web of film to a plurality of predetermined lengths of film and filling containers with said plurality of cut lengths.

It is another object of the present invention to provide a rotary edible film web cutting tool.

It is another object of the present invention to provide a rotary cutting tool for cutting edible film webs into predetermined lengths and filling containers with said lengths.

It is still another object of the present invention to provide an apparatus for cutting film webs into predetermined lengths, filling containers with said lengths and sealing said filled containers.

It is yet another object of the present invention to provide a method of cutting film webs into predetermined lengths, filling containers with said lengths and sealing said filled containers.

It is yet a further object of the present invention to provide a device that cuts at least one film web longitudinally prior to cutting said web transversely.

### DESCRIPTION OF THE DRAWINGS

FIG. 1 is a perspective view of a preferred embodiment of the front side of the apparatus of the present invention;

FIG. 2 is a perspective view of a preferred embodiment of the back panel of the apparatus of the present invention;

FIG. 3 is a perspective view of a detail of a preferred embodiment of the invention according to FIG. 1;

FIG. 4 is a top perspective view of a preferred embodiment of the elements of the cutting device of the present invention;

FIG. 5 is a perspective view of a preferred embodiment of the cutting device of the present invention;

FIG. 6-6e are graphical representations of screen shots of a preferred embodiment of the touchscreen of the present invention;

FIG. 7 is a front perspective view of a preferred embodiment of an application of the invention according to FIG. 1;

FIG. 8 is a front perspective view of a preferred embodiment of an application of the invention according to FIG. 1;

FIG. 9 is a perspective view of a detail of a preferred embodiment of the invention;

FIG. 10 is a perspective view of a detail of a preferred embodiment of the invention;

FIG. 11 is a perspective view of a preferred embodiment of the apparatus of the present invention;

FIG. 12 is a perspective view of an application of a preferred embodiment of the apparatus of the present invention;

FIG. 13 is a side view of a preferred embodiment of the capping apparatus of the present invention;

FIG. 13A is a front view of a preferred embodiment of the channel of the present invention; and

FIG. 14 is a schematic representation of a preferred embodiment of the operation of the capper apparatus of the present invention.

### DETAILED DESCRIPTION OF THE PREFERRED EMBODIMENTS

In the following description, for purposes of explanation, specific numbers, materials and configurations are set forth in order to provide a thorough understanding of the invention. It will be apparent, however, to one having ordinary skill in the art that the invention may be practiced without these specific details. In some instances, well-known features may be omitted or simplified so as not to obscure the present invention. Furthermore, reference in the specification to “one embodiment” or “an embodiment” means that a particular feature, structure or characteristic described in connection with the embodiment is included in at least one embodiment of the invention. The appearances of the phrase “in one embodiment” in various places in the specification are not necessarily all referring to the same embodiment.

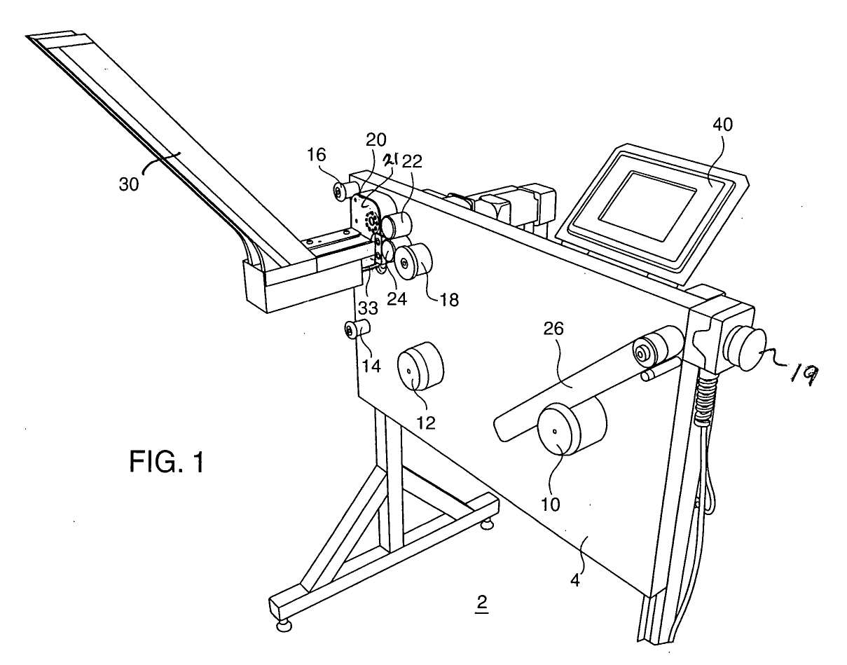

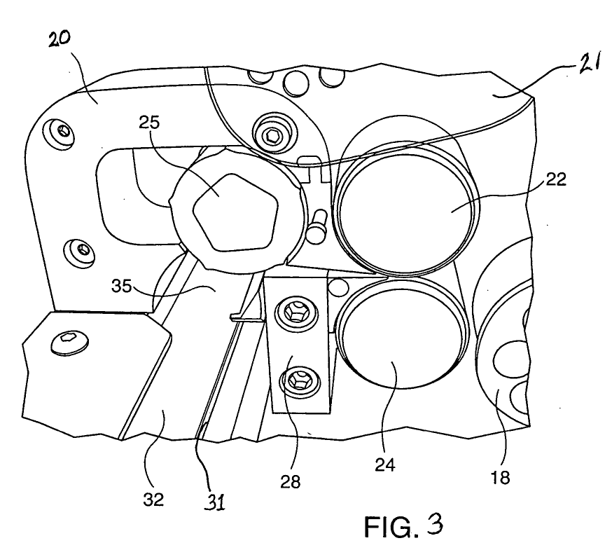

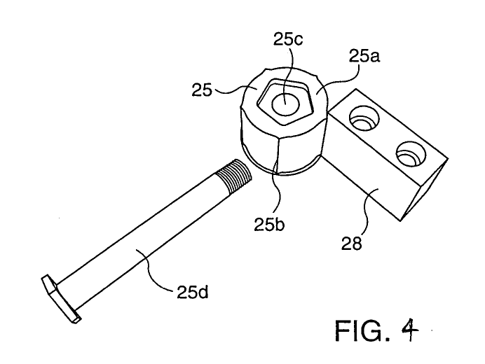

Now referring to FIGS. 1-3 a preferred embodiment of the device 2 comprises essentially a body 4 upon which are mounted cutting housing 20, container dispenser 30, channel 31, conveyor 32, drive means 60, 62, 64, 66 and 68, user interface 40 and start/stop switch 19. Body 4 further comprises reels 10 and 12, roller guides 14, 16 and 18 and guide arm 26. The device 2 further comprises feed rollers 22 and 24, cutting tool 25, cutting block 28 and protective shield 21. A filling station 35 is provided.

Guides 14, 16 and 18 may be free spinning or fixed.

Reels 10 and 12 are preferably equipped with fans (not shown).

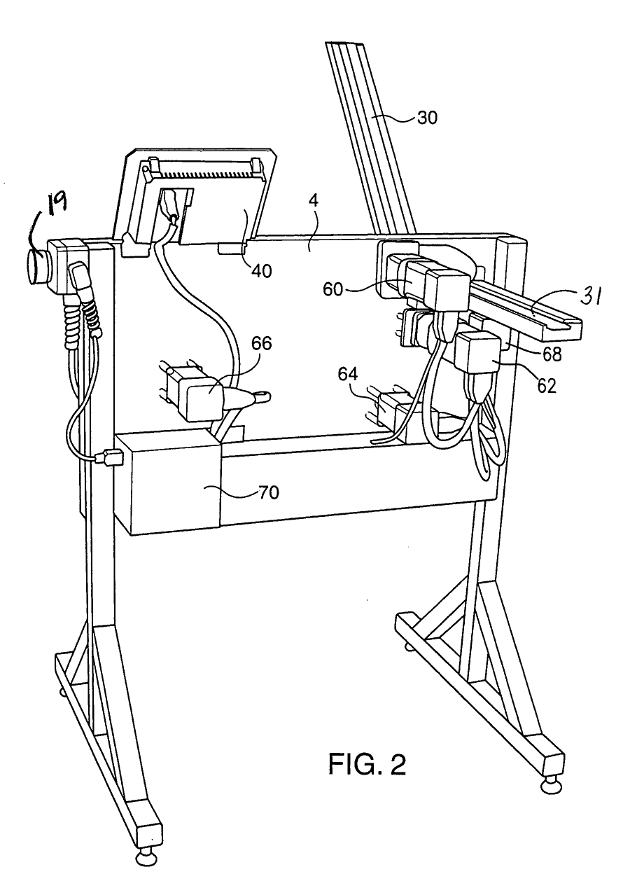

Now referring to FIG. 2 drive means 60 drives cutting device 25. Drive means 62 drives either or both of feed rolls 22 and/or 24. Drive means 64 drives reel 12. Drive means 66 drives reel 10. Drive means 68 drives conveyer 32 via drive shaft 33. In a preferred embodiment device 2 may be powered by a mounted power supply 70 such as a battery. Alternatively, a 110 or 240V AC single phase power supply is employed. In a most preferred embodiment drive means 60, 62, 64, 66 and 68 comprise integrated motors such as but not limited to SmartMotors™ commercially available from Animatics® of Santa Clara, Calif. Each SmartMotor™ is an integrated control system comprising a brushless DC servo motor, motion controller, encoder and amplifier, programmed to execute upon receipt of an appropriate signal. Employing integrated motors, position, velocity and acceleration of the elements of the device 2 are precisely controlled. Preferably interface 40 is linked via RS-232 to drive means 60 which preferably comprises an Animatics SM2330 SmartMotor™. In this embodiment drive means 60 is linked via RS-485 to the remaining drive means 62-68 which preferably comprise Animatics SM2337 SmartMotors™. Connections between drive means are any suitable cable such as but not limited to that commercially available from Servosystems of Montville, N.J.

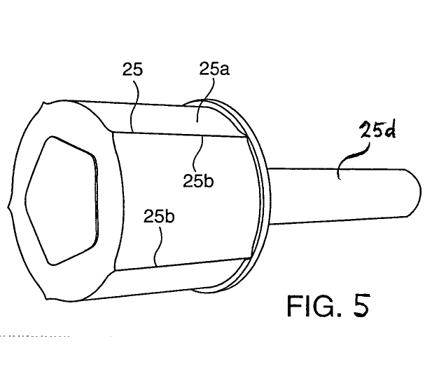

Now referring to FIGS. 4 and 5 in a most preferred embodiment cutting tool 25 comprises a generally cylindrical body 25a having at least one cutting surface 25b and a central bore 25c. Cutting tool 25 is disposed on shaft 25d.

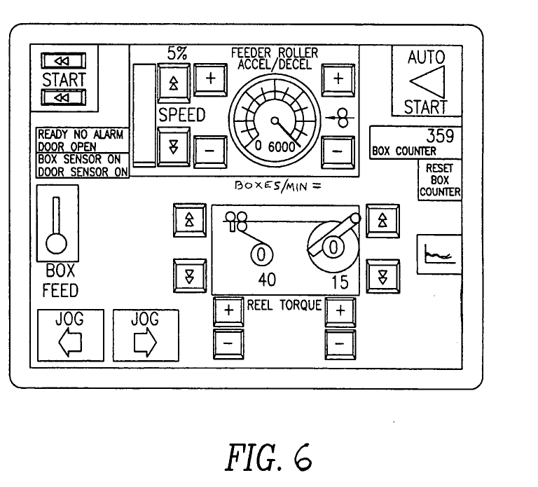

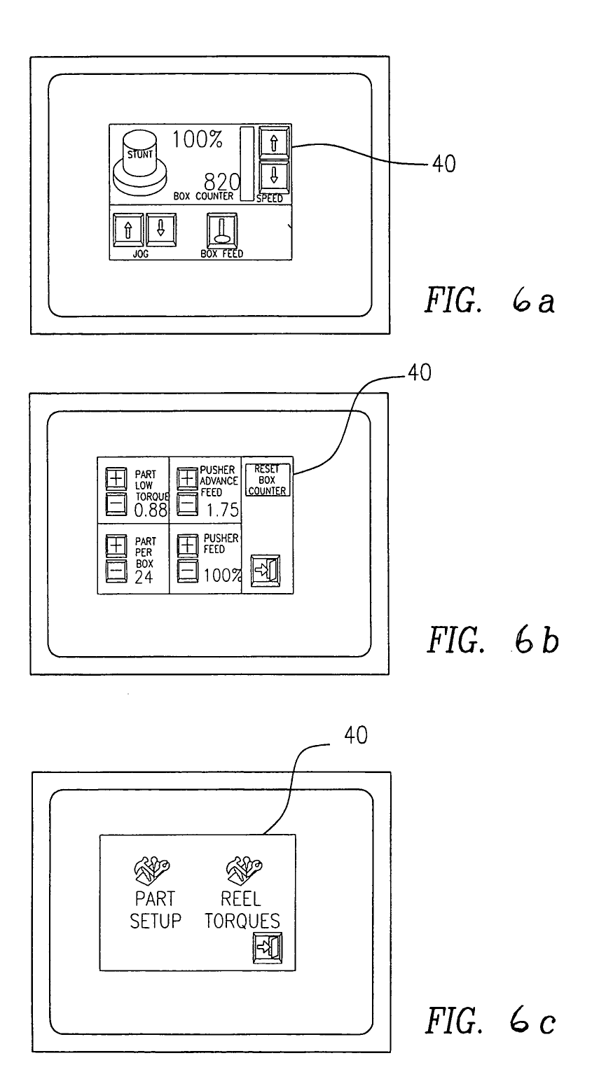

Now referring to FIGS. 6-6e in a most preferred embodiment interface 40 comprises a touch screen that is a man-machine interface permitting the operator to input the parameters necessary to govern the device 2. Suitable touch screens include commercially available touchscreens such as but not limited to the MMI-1500 available from Kessler-Ellis Products of Eatontown, N.J. Now referring to FIGS. 6-6e, interface 40 comprises a plurality of screens containing function keys to control start/stop, reel speed, box feed speed, length of cut, pieces per box, reel torque, roller guide speed and the like. Now referring to FIG. 6e user interface 40 preferably provides for protecting settings with a password.

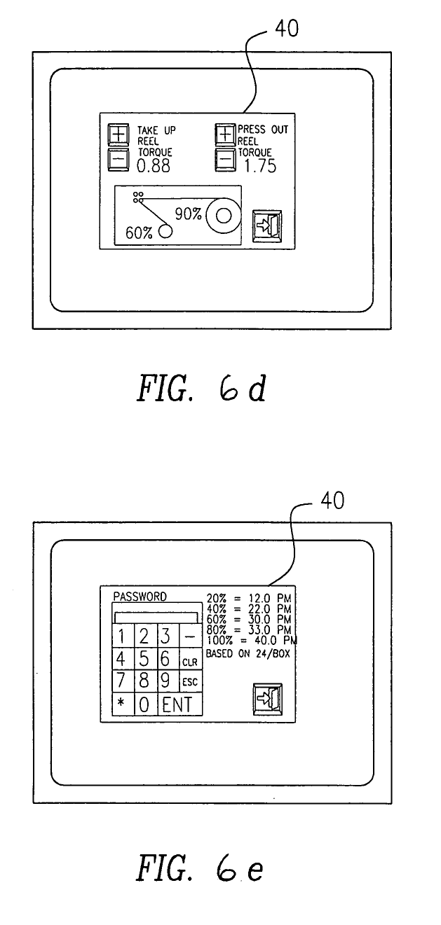

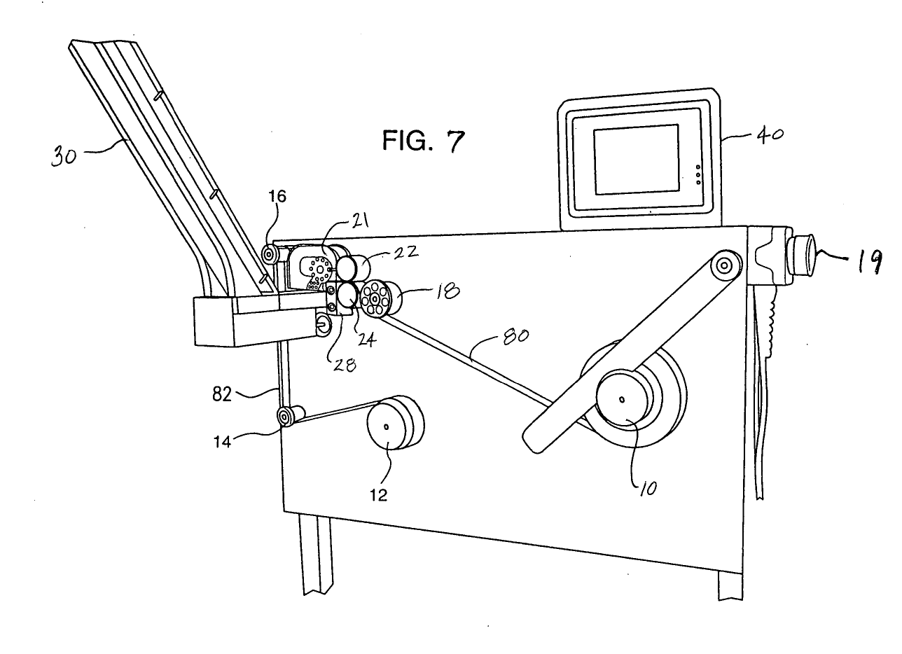

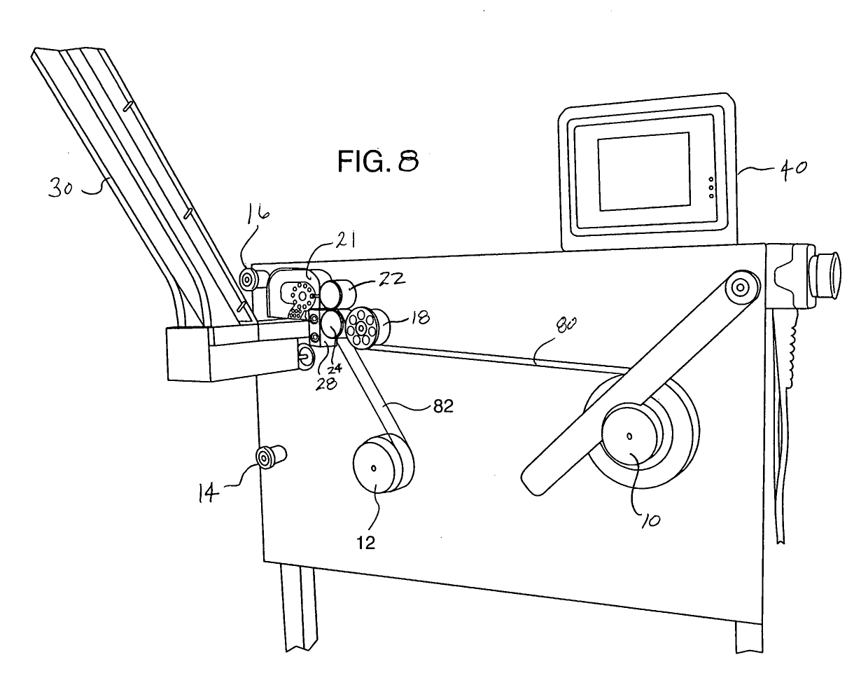

Now referring to FIGS. 7-10 a web 80 preferably of film is mounted on reel 10 and a leading edge of said web 80 is fed to roller guide 18 and between rollers 22 and 24 and then between cutting tool 25 and cutting block 28. Web 80 may be supported by web 82 or unsupported and may be mounted with leading edge of said web 80 fed from the bottom (e.g. FIG. 7) or the top (e.g. FIG. 8) of reel 10. Now referring to FIGS. 7 and 8 in a preferred embodiment reel 12 is employed as a takeup wheel for the supporting web 82. Referring to FIG. 7 in one embodiment supporting web 82 is fed over cutting station 20 and around roller guides 16 and 14 to takeup reel 12. Now referring to FIG. 8 in an alternate embodiment supporting web 82 is fed directly from roller 24 to takeup reel 12. In a preferred embodiment heat is applied to supporting web 82 to reduce curl.

In another embodiment only one of rollers 22 and 24 is operably linked to drive means 62 resulting in only one of the two rollers being power driven while the other spins passively, the web 80 being pinched between the rollers 22 and 24. Reel 10, operably linked to drive means 66, preferably operates to apply tension to web 80 by means of application of force in the direction opposite the web 80 feed. Preferably reel 10 is reversible. Guide arm 26 is pivotably engaged to body 4 to prevent web 80 from becoming uncoiled when mounted on reel 10. Reels 10 and 12 preferably further each comprise a knock-out device (not shown) such as but not limited to a ring, concentric with said reel, connected to a push bar located at the back of device 2 to facilitate removal of web spools.

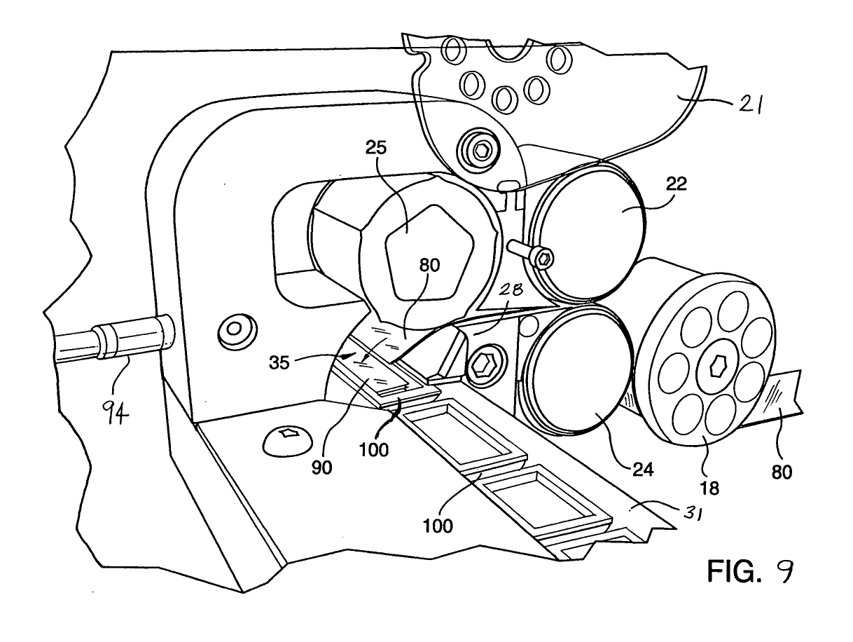

Now referring to FIG. 9, web 80 is fed between cutting tool 25 and cutting block 28. Web 80 is cut into a plurality of predetermined lengths 90 by the rotary action of cutting tool 25. Shield 21 is pivotably mounted to housing 20.

Now referring to FIGS. 9, 10 and 12, in a most preferred embodiment device 2 further comprises static control device 94 such as but not limited to an ionizer, preferably disposed in cutting housing 20. Suitable static control devices 94 include but are not limited to static bars such as those commercially available from Simco of Hatfield, Pa. In a preferred embodiment a neutralizing power supply (not shown) such as one commercially available from Simco is employed in connection with said static control device 94.

Dispenser 30 holds a plurality of containers 100 for receiving the cut lengths of film 90. The dispenser 30 may employ a biasing means such as but not limited to a spring or spring loaded device such as a plunger to exert pressure on said containers 100 to advance the containers 100 along the length of the dispenser 30 toward and through the filling station 35. In one embodiment the dispenser 30 is a chute-type dispenser extending from channel 31, which is aligned with filling station 35. The dispenser 30 is preferably adapted to handle several different types of containers such as but not limited to those commercially available from Moldieco of Fords, N.J. and the Sweetbreath container from Healthtech of Totowa, N.J. Containers 100 are advanced to filling station 35 along channel 31 by conveyor 32 or another means known to one having skill in the art. Dispenser 30 is preferably equipped with a misfeed sensor such as but not limited to a sensor electrically connected to motor 68 so that if the dispenser 30 is empty, jams or otherwise ceases feeding containers to the conveyor 32 the device 2 ceases operation.

As lengths 90 are cut they are stacked and loaded into containers 100 that have been advanced to filling station 35, preferably as each cycle of cutting tool 25 is completed. In a preferred embodiment cutting tool 25 rotates a specified number of times per cycle, depending on the number of cut lengths 90 desired per container 100. The operator can control this parameter by means of interface 40. FIGS. 6a-e illustrate various parameters that may be controlled by the operator.

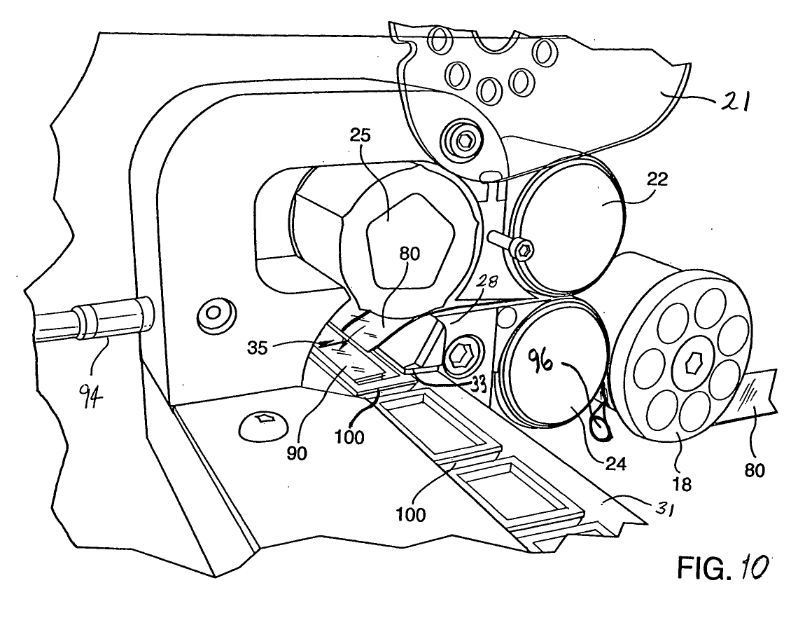

Now referring to FIG. 10 in a preferred embodiment device 2 further comprises slitting device 96, such as but not limited to a blade. Slitting device 96 cuts web 80 longitudinally so that parallel webs 80 are made from one roll and introduced to cutter 25.

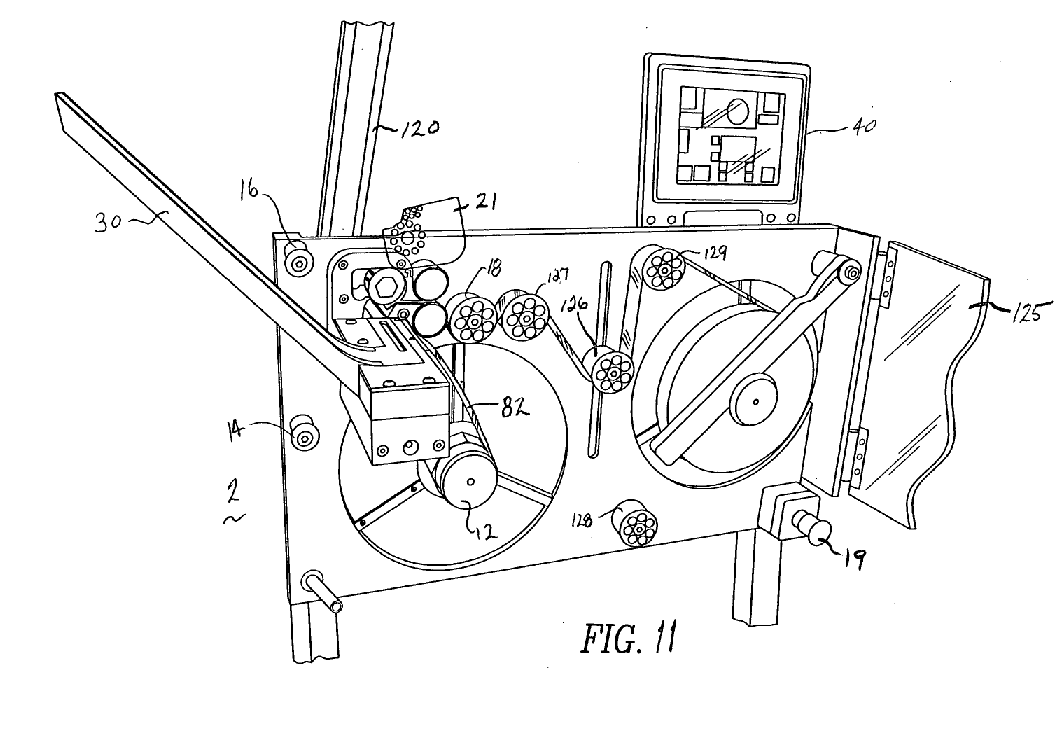

Now referring to FIG. 11, in a most preferred embodiment device 2 comprises cover dispenser 120, safety door 124, dampening shock absorber 126 and additional guides 127, 128 and 129. Dampening shock absorber 126 maintains proper tension on web 80 and moves upward and downward as required during operation of device 2. In the embodiment of FIG. 11 reel 12 is employed as a takeup reel for supporting web 82.

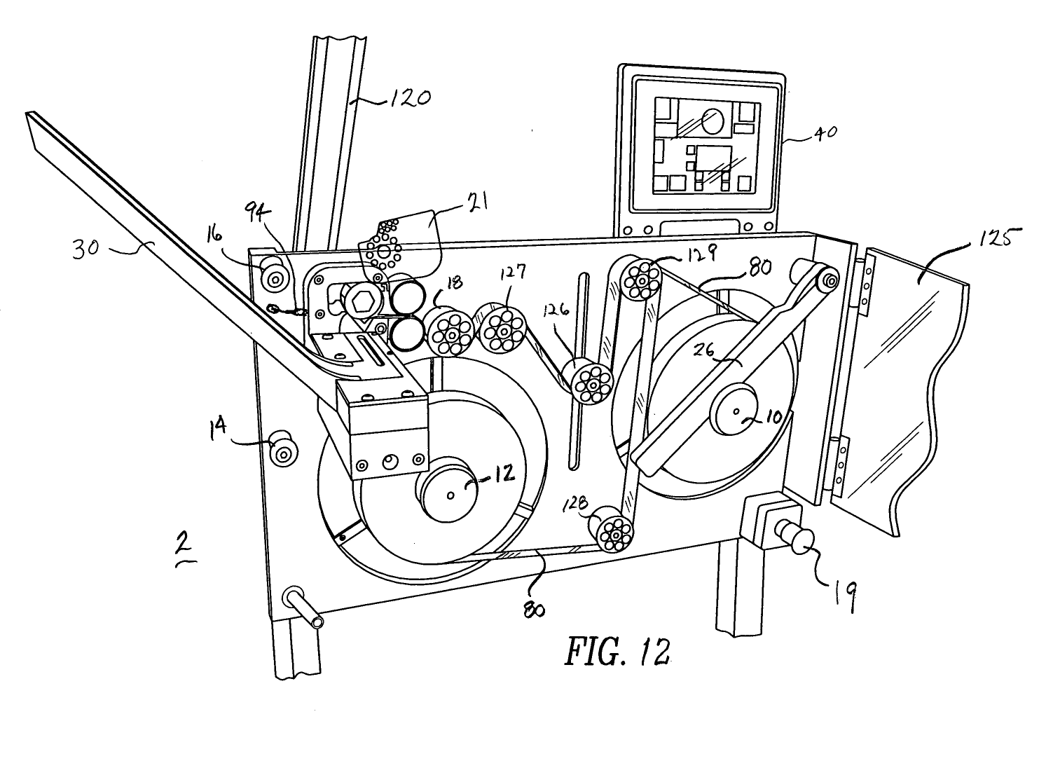

Now referring to FIG. 12, in a most preferred embodiment two unsupported webs 80 are run simultaneously, with an unsupported web 80 mounted on each of reels 10 and 12.

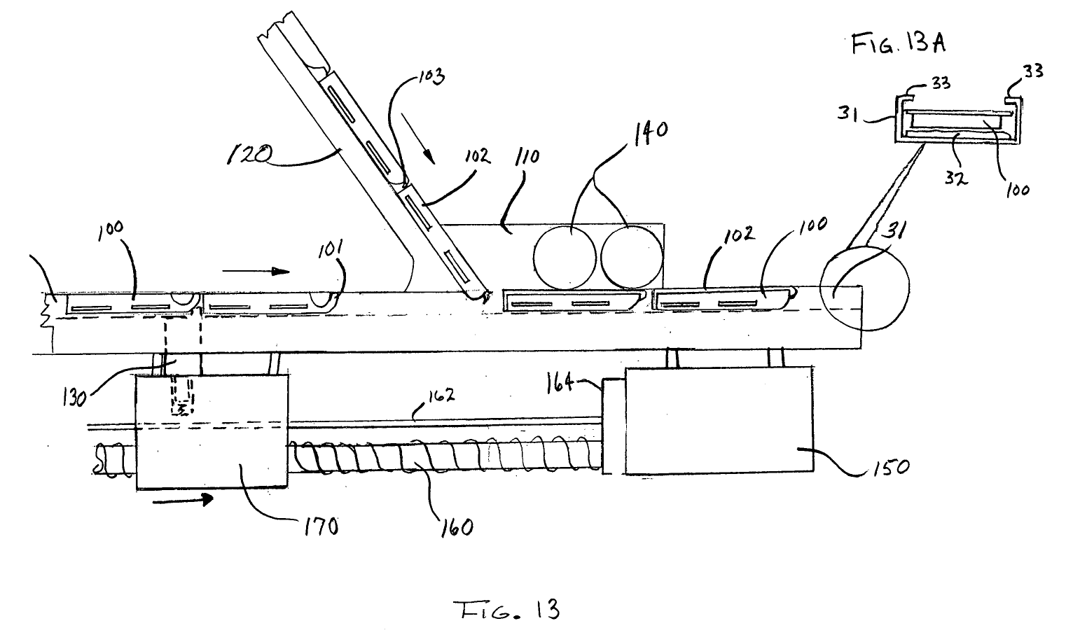

Now referring to FIG. 13, in a further embodiment filled containers 100 are advanced to a sealing station 110 along channel 31 where a cover 102 is disposed over said container 100. In a preferred embodiment a cover-dispensing device 120 such as but not limited to a chute dispenser or magazine is configured to dispense a plurality of container covers 102. The cover-dispensing device 120 dispenses a cover 102 to the sealing station 110 where said cover 102 is disposed on a container 100 and advanced out of the sealing station 110 along channel 31. In one embodiment, a pushing plunger 130, such as but not limited to a spring-loaded plunger, situated under the channel 31 drives the container 100 into engagement with a cover 102, which is adapted to securely engage the container 100. As containers 100 are conveyed along channel 31, a leading container passes over and depresses plunger 130, rides over said plunger 130 and after passing over said plunger 130, plunger 130 recovers to an unbiased position, the raised leading edge 132 thereof engaging the rear end of container 100. Now referring to FIG. 13A, in one embodiment channel 31 comprises flanges 33 to prevent container 100 from rising out of the channel 31 when passing over plunger 130. In one embodiment, a motor 150 drives screw 160 to advance a carriage 170 carrying plunger 130 along rail 162 to stop 164, carrying a container 100 to sealing station 110 where said container 100 engages a cover 102. Preferably, the cover 102 comprises a lip 103 adapted to hook onto a front edge 101 of a container 100 and the container 100 and cover 102 are passed through pinch rollers 140 to securely fasten the cover 102 to the container 100 with the film inside. Motor 150 then returns carriage 170 to permit plunger 130 to engage the next container 100 in the queue.

In a most preferred embodiment motor 150 is a SmartMotor™ in active communication with at least one of said other SmartMotors™ such that the action of one motor is coordinated with the action of another. For example, the initial action of the motor 150 to drive the container toward the sealing station 110 may be activated by the action of drive means 60 which operates cutter 25. Motor 150 may be programmed to drive screw 160 clockwise upon the completion of a cycle of cutter 25. Other programming variations may be employed.

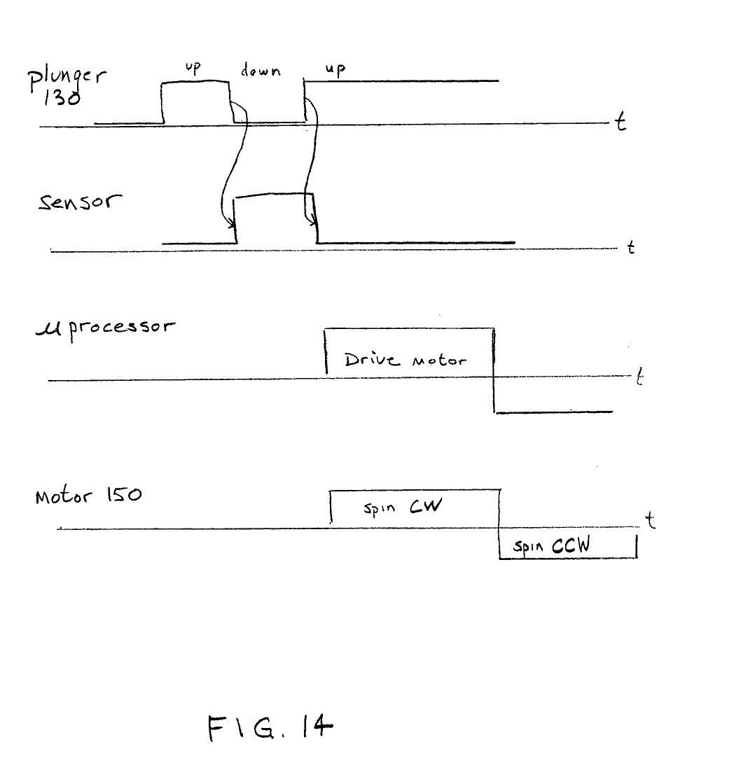

Now referring to FIG. 14, in an alternative embodiment, plunger 130 is connected to a sensor (not shown) which is connected to a microprocessor (not shown) which communicates with motor 150. When plunger 130 is depressed and recovers, the sensor sends a signal to the microprocessor which is programmed to drive motor 150 in one direction, e.g., clockwise, for a given length of time to advance carriage 170, and in an opposite direction, e.g., counterclockwise, for another length of time to return carriage 170.

In accordance with the apparatus described herein, a method is provided for cutting at least one film web 80 employing a rotary cutting tool 25, providing a container for receiving said cut lengths 90, and loading said cut lengths 90 in said container 100.

Preferably the length and quantity of said cut lengths 90 is predetermined. In a most preferred embodiment, the method further comprises advancing the filled container 100 from the filling station 35, such as but not limited to by means of a stop gate that is actuated at the conclusion of a rotation cycle of said cutting tool 25 to drop, and rise prior to the beginning of the next cycle, the next container 100 taking its place for filling. Alternatively a conveyer 32 is provided to advance the containers 100.

While the preferred embodiments have been described and illustrated it will be understood that changes in details and obvious undisclosed variations might be made without departing from the spirit and principle of the invention and therefore the scope of the invention is not to be construed as limited to the preferred embodiment.

1. An apparatus for cutting at least one web of film transversely comprising a web holding apparatus, at least one web cutting tool, a web advancing apparatus which advances said web to said cutting device, and a container dispensing device which dispenses containers to receive cut web lengths.

2. The apparatus according to claim 1 further comprising a means for controlling the operation of the apparatus.

3. The apparatus according to claim 1 said cutting device comprising at least one rotary cutting tool having at least one cutting surface.

4. The apparatus according to claim 1 said cutting tool comprising a substantially cylindrical cross-section and having a plurality of cutting surfaces disposed longitudinally thereon.

5. A method for separating at least one web of film comprising providing at least a first web of film, advancing said web to a rotary cutting tool, cutting said film web, providing a container to receive at least one cut length, and introducing said at least one cut length into said container.

6. The method according to claim 5 comprising the further steps of providing means for advancing said container to a station for receiving said cut lengths, and advancing said container away from said station.

7. The method according to claim 5 comprising cutting said at least one web to at least one predetermined length.

8. The method according to claim 5 comprising rotating said rotary cutting tool a predetermined number of times.

9. The method according to claim 5 comprising separating said web longitudinally prior to the introduction of said web to said rotary cutting tool.

10. An apparatus for cutting at least one web of film transversely comprising a web holding apparatus, at least one rotary cutting tool, and a web advancing apparatus which advances said web to said cutting tool.

11. The apparatus according to claim 10 further comprising a device for advancing containers to a position for receiving said cut lengths.

12. The apparatus according to claim 11 further comprising an apparatus for placing a cap on said container.

13. The apparatus according to claim 10 said web advancing apparatus comprising at least one reel and pinch rollers.

14. The apparatus according to claim 13 comprising drive means for rotating said at least one reel and at least one of said pinch rollers.

15. The apparatus according to claim 10 further comprising a control device comprising a user interface linked to a CPU.

16. The apparatus according to claim 10 further comprising a slitting device.

17. The apparatus according to claim 14, at least one of said drive means comprising a motor.

18. The apparatus according to claim 17, said motor comprising a programmable motor.

19. The method according to claim 5 said at least one web comprising an edible film web.
